(19) United States
(12) Patent Application Publication
(10) Pub. No.: US 2017/0274451 A1
(43) Pub. Date: Sep. 28, 2017

(54) ELECTROCHEMICAL MACHINING INNER CONTOURS OF GAS TURBINE ENGINE COMPONENTS

(71) Applicant: SIEMENS AKTIENGESELLSCHAFT, MÜNCHEN (DE)

(72) Inventors: PHILIP HATHERLEY, LINCOLN (GB); SUSANNE KAMENZKY, BERLIN (DE); GARY B. MERRILL, ORLANDO, FL (US); SAMUEL R. MILLER, Jr., PORT ST. LUCIE, FL (US); DIMITRIOS THOMAIDIS, BERLIN (DE)

(21) Appl. No.: 15/518,570

(22) PCT Filed: Aug. 6, 2015
(86) PCT No.: PCT/US2015/043971

§ 371 Date: Apr. 12, 2017

Related U.S. Application Data
(60) Provisional application No. 62/068,099, filed on Oct. 24, 2014.

(51) Int. Cl. B22D 31/00; F01D 5/18; B23H 9/16; B23H 3/04; B23H 9/10

(52) U.S. Cl. CPC B22D 31/002; B23H 3/04; B23H 9/10; B23H 9/16; F01D 5/18; B23P 15/02

(57) ABSTRACT

A method of forming a component for a gas turbine engine, including: casting a component around a ceramic core, wherein the ceramic core forms a pilot channel (40) in the component, the pilot channel oriented from a base (176) to a tip (20) of the component; sinking an ECM electrode into the pilot channel; and enlarging the pilot channel to form an inner surface of an external wall (120) of the component via electro-chemical machining, wherein a contour (94) of the inner surface is different than a contour of the pilot channel.

### CROSS REFERENCE TO RELATED APPLICATIONS

This application is a U.S. National Stage Application of International Application No. PCT/US2015/043971, filed Aug. 6, 2015, which claimed priority to U.S. Provisional Patent Application No. 62/068,099, filed on Oct. 24, 2014. The entirety of each application is incorporated by reference herein in its entirety.

### FIELD OF THE INVENTION

The invention relates to forming inner contours of a component for a used in a gas turbine engine such as a blade or vane using an electrochemical machining process.

### BACKGROUND OF THE INVENTION

Investment casting may be used to produce hollow parts having internal cooling passages such as blades and vanes used in gas turbine engines. During the conventional investment casting process wax is injected into a wax cavity to form a wax pattern between a core and a wax die. The wax die is removed and the core and wax pattern are dipped into the ceramic slurry to form a ceramic shell around the wax pattern. The wax pattern is thermally removed, leaving a mold cavity. Molten metal is cast between the ceramic core and the ceramic shell, which are then removed to reveal the finished part.

Any movement between the ceramic core and the wax die may result in a distorted wax pattern. Since the ceramic shell forms around the wax pattern, and the ceramic shell forms the mold cavity for the final part, this relative movement may result in an unacceptable part. This is particularly so for thin-walled components, where a shift may change the wall thickness by a relatively large percentage. Likewise, any movement between the ceramic core and the ceramic shell when casting the airfoil itself may result in an unacceptable part. This nature of the investment casting process, where two discrete parts must be held in a single positional relationship during handling and multiple casting operations, makes holding the tolerances difficult.

In order to overcome this relative shifting, U.S. Pat. No. 5,296,308 to Caccavale et al. describes one approach where a ceramic core has bumpers on the ceramic core that touch, or almost touch, the wax die during the wax pattern pour. This controls a gap between the ceramic core and the wax die, and likewise controls a gap between the ceramic core and the ceramic shell. Controlling the gap minimizes shifting between the ceramic core and the ceramic shell, and this improves control of the wall thickness of the airfoil. The bumpers are positioned at key stress regions to counteract distortions. However, the final part may have a hole where the bumpers were located, between an internal cooling passage and a surface of the airfoil, which allows cooling fluid to leak from the internal cooling passage. Consequently, there remains room in the art for improved methods of forming

### BRIEF DESCRIPTION OF THE DRAWINGS

The invention is explained in the following description in view of the drawings that show:

FIG. 1 is a top schematic view of a twisted gas turbine engine blade before electrochemical machining.

FIG. 2 is a radial cross-section showing a pilot channel in the blade of FIG. 1 being enlarged into an intermediate channel contour by electrochemical machining.

FIG. 3 is the radial cross section of FIG. 1 showing the intermediate channel formed in FIG. 2 being enlarged into a final cooling channel contour by electrochemical machining.

FIG. 4 is a side view of an electrochemical machining electrode with masking.

FIG. 5 is a top view of a twisted electrochemical machining electrode.

FIG. 6 is a side cross section of a blade all of the interior surface of the blade formed via the electrochemical machining process.

### DETAILED DESCRIPTION OF THE INVENTION

The present inventors have developed a novel way to form a gas turbine engine component such as a blade or vane. The component may be a thin-walled component such as an airfoil having cooling channels under a thin exterior wall. The inventors propose to form a pilot channel in the component and then enlarge the pilot channel until a final interior contour of the component is formed using electrochemical machining (ECM). An ECM electrode will be lowered into the pilot channel and excess material may be removed from beneath a tip of the electrode as it is lowered as well as from locations astride the tip of the electrode when being lowered and/or when stationary. The electrode may be shaped or masked to form desired inner contours and may be masked to form flow-interrupting elements inside the channel being formed. The pilot channel may be formed as part of a casting operation. In such an instance the component is cast around a core to form a cast monolith having the pilot channel formed therein. Alternately, the pilot channel may be machined via conventional techniques such as drilling, electro discharge machining, or electrochemical machining. When the pilot channel is formed via ECM, the entire interior volume of the component may be formed via ECM. The component to be electro machined may be cast or formed through any methods known to those in the art. The component to be machined may alternately be formed without a pilot hole. For example, a component may be cast without a pilot hole and then all interior machining is carried out via ECM.

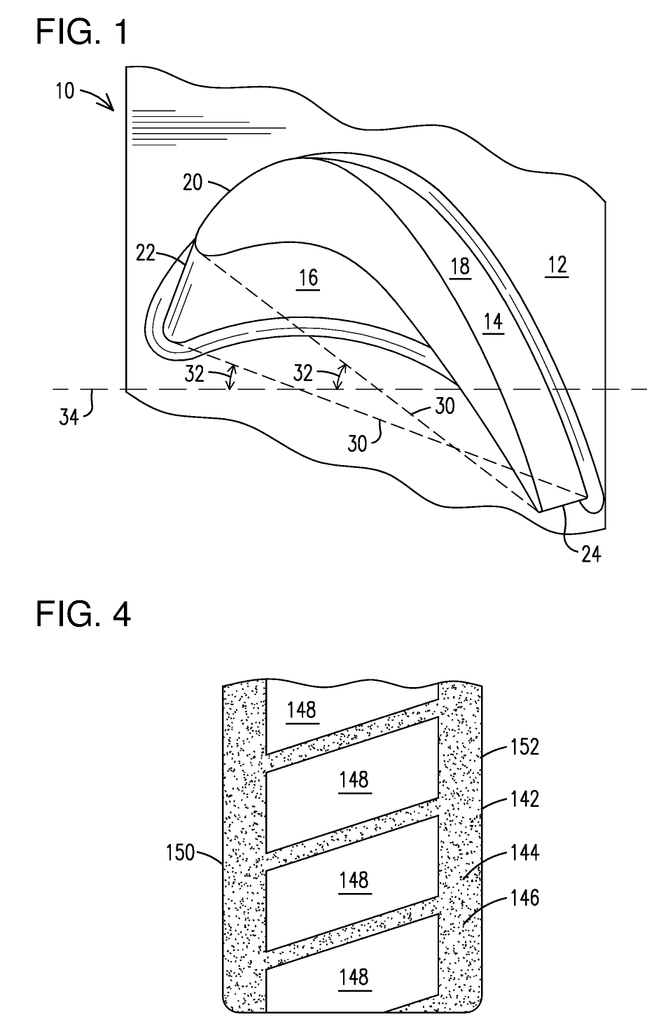

FIG. 1 shows a twisted blade 10 used in a gas turbine engine. The blade 10 includes a base (not visible), a platform 12, and an airfoil 14 with a pressure side 16 and a suction side 18. Certain airfoil designs include a twist in the airfoil from the base of the airfoil 14 radially outward toward a tip 20 of the airfoil 14. For any given radial cross section of the airfoil 14, a line connecting a leading edge 22 of the airfoil to the trailing edge 24 forms a chord line 30. A radially inward projection of the chord line forms an angle 32 with a longitudinal axis 34 of a rotor shaft (not shown) of the gas turbine engine. When the angle 32 formed changes from one radial cross section to the next as shown in FIG. 1, the airfoil 14 may be considered twisted.

Twisted airfoils present challenges for conventional machining processes such as drilling because drilling produces straight holes/channels with a circular cross section having a single diameter (per drilling operation). Consequently, drilled holes cannot follow the twist of the airfoil nor can they create the complicated inner contours (e.g. shapes) preferred. However, the process disclosed herein is compatible with twisted airfoils (as well as non-twisted airfoils) because the electrode itself can be twisted and because the electrode can be shaped and/or masked to machine various contours.

In the exemplary embodiment of FIG. 1, the entire blade 10, including the base, the platform 12, and the airfoil 14 is solid (i.e. devoid of hollow interior spaces), awaiting for the inner contours to be formed.

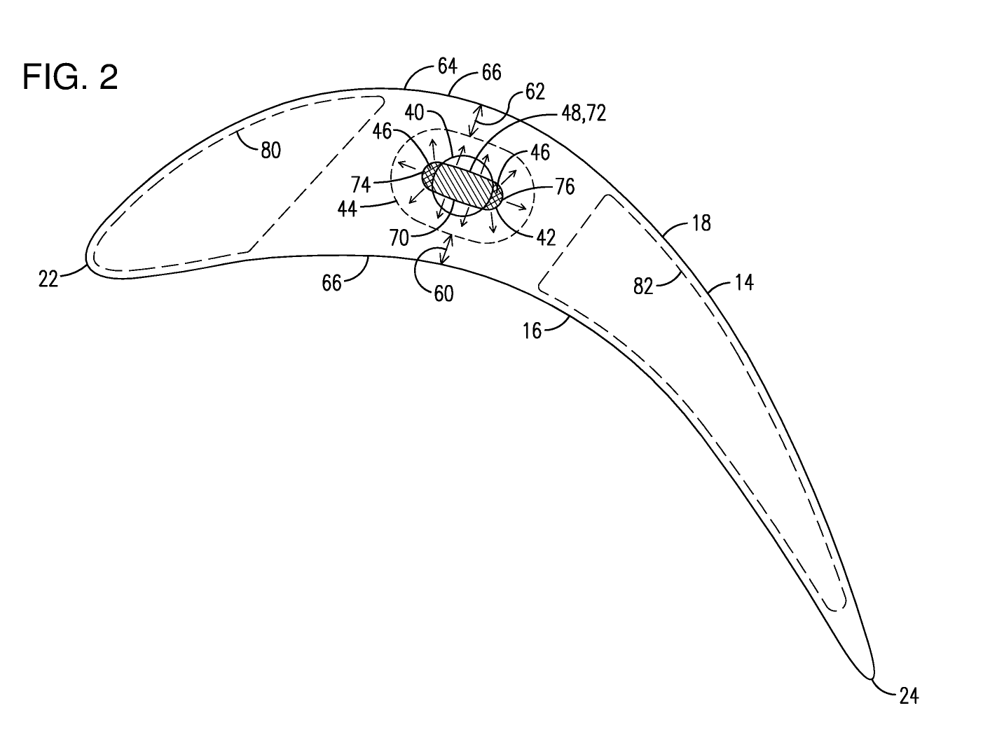

FIG. 2 shows a radial cross section where a pilot channel 40 has been formed in the airfoil 14. The pilot channel 40 is oriented from the tip 20 of the airfoil 14 to the base of the airfoil 14 and may extend all the way through the base of the blade 10 to form a “deep” through-hole through the blade 10. The pilot channel 40 is located so that it can be enlarged to form a middle cooling channel (not shown). The pilot channel 40 may be formed by any means known to those in the art. For example, if the airfoil 14 is straight, the pilot channel 40 may simply be drilled. If the airfoil 14 is straight or twisted, the pilot channel 40 may be formed by various other methods, including electro-discharge machining and electro-chemical machining etc. The pilot channel 40 may alternately be formed as part of the casting operation. The use of a core to form an interior void and the associated concerns regarding shifting are rendered moot because any anomalous dimensions resulting from shifting will be machined out during the subsequent electrochemical machining operation. The pilot channel 40 may have a constant diameter along its entire length, or the diameter may vary so more or less material would need to be removed when compared to a pilot channel 40 of constant diameter.

For example, a core used to form a varying diameter pilot channel 40 may be narrower at its base and/or tip, and wider in its middle if the channel to be formed follows this general shape. This way the middle region would take less time to electrochemical machine when compared to a pilot channel 40 of constant diameter.

In the exemplary embodiment shown the pilot channel 40 will first be enlarged using a first electrode 42 that will enter the pilot channel 40 at a first location (e.g. at one end of the pilot channel 40). The first electrode 42 will be use in the electrochemical machining process to form an intermediate channel having an intermediate channel contour 44 that represents a surface of the intermediate channel once it is formed. In the exemplary embodiment the first electrode 42 may be lowered from the tip 20 of the airfoil 14 toward the platform 12 of the airfoil 14, and may continue through the base of the airfoil. The tip 20 is smaller and channel formation at the tip 20 may require greater process control, and greater process control occurs with electrochemical machining when a tip of the electrode is closer to the base unit. For example, the farther the tip of the electrode is from the electrode clamping system of the electrochemical machining system, the more it may move laterally, thereby reducing dimensional control. Such lateral movement may occur when the electrolyte used in the ECM process flashes, causing the electrode 42 to move or vibrate.

The intermediate channel will be subsequently enlarged via ECM using a second, different electrode to form a final channel. The second electrode may be inserted into the component at the same location (e.g. same end of the pilot channel 40) as was the first electrode 42. Alternately, the second electrode may be inserted from another location on the component, for example, the opposite end of the pilot channel 40. The choice of using the same entry location or different entry locations applies to all channels formed via ECM using the first electrode 42 and the second electrode. In general, the final channel may alternately be formed from the pilot channel 40 in one electrochemical machining (enlarging) operation, or it may take several different electrochemical machining operations, and the electrode used during each operation may be the same or different than electrodes using during the other operations. The electrodes may be different in cross sectional shape, diameter, length, twist, and amount and pattern of the masking, etc. as necessary to reach the desired final contour. In addition, the electrodes may remove material in front of a tip of an advancing electrode and/or astride sides of the electrode when the electrode is advancing or when it is stationary.

As shown in FIG. 2, the pilot channel 40 has a circular cross sectional shape, while the first electrode 42 has an oval cross sectional shape, and the first electrode 42 would not fit within the pilot channel 40. Differing cross section shapes may be used when a desired intermediate channel contour 44 has a different cross sectional shape than does the pilot channel 40 and when the first electrode 42 is not masked. In such instances the intermediate channel contour 44 will resemble the shape of the first electrode 42. The first electrode 42 may be larger than the pilot channel 40 when, for example, for manufacturing purposes it is easier to use one first electrode 42 to form intermediate channels in different sized airfoils having various sized pilot channels 40 etc.

Once electrochemical machining commences in FIG. 2, material below the tip of the first electrode 42 (into the page) in tip-machined regions 46 will be removed as the first electrode 42 advances. Material adjacent a side 48 of the first electrode 42 will be removed laterally (away from the side 48 toward the intermediate channel contour 44) as indicated by the arrows.

As the first electrode 42 sinks into the airfoil 14 a thickness of the airfoil 14 increases. To maintain a desired pressure side intermediate wall thickness 60 and/or suction side intermediate wall thickness 62, a feed rate at which the first electrode 42 is lowered into the airfoil 14 may be controlled. In conventional electrochemical machining, the feed rate is typically selected to match a steady-state rate of liquefaction of the material being machined (material liquefaction rate) that occurs under the given set of electrochemical machining conditions, including, for example, the amount of current being used etc. This is done because the electrode is advancing toward the material being machined. This provides the fastest possible machining of the component. However, the process disclosed herein also machines material positioned on the sides of the electrode, as opposed to only in front of an advancing electrode. Accordingly, the electrode feed rate may be slowed to a rate below the material liquefaction rate. The slower electrode feed rate slows the passing of the electrode past the material astride the electrode, and this allows for the removal of more material astride the electrode than would occur of the electrode feed rate equaled the material liquefaction rate.

Stated another way, the first electrode 42 may produce a channel having more than one diameter simply by changing the electrode feed rate. In exemplary embodiments where there is no material in front of the first electrode 42, the electrode feed rate may even be greater than the material liquefaction rate if it is desired to minimize machining of material astride the first electrode 42.

For example, to maintain a specified wall thickness the feed rate the first electrode 42 is lowered may be slowed to below the liquefaction rate as the tip of the first electrode 42 approaches the base of the airfoil 14. The amount of material removed increases as the first electrode 42 is slowed. Thus, a diameter of the intermediate channel will increase with the increasing (overall) thickness of the airfoil 14 in order to ensure the intermediate wall thicknesses are controlled as desired.

In an exemplary embodiment, the intermediate wall thicknesses may remain constant from the tip 20 of the airfoil 14 to the base. In this case the intermediate wall thicknesses are directly responsive to an outer contour 64 of the airfoil 14 from the tip 20 to the base, where the outer contour 64 is defined by an outer surface 66 of the airfoil 14. If the intermediate wall thickness is constant at any given radial cross section then the intermediate wall thickness is directly responsive to the outer contour 64 at the given radial location. Alternately, the intermediate wall thicknesses may increase toward the base, but the diameter of the intermediate channel contour 44 may also increase. In this case the wall thickness is different for two different radial cross sections, but within each radial cross section the thickness is the same. In this case the intermediate wall thickness is indirectly responsive to the outer contour 64 from the tip 20 to the base. So long as a relationship between the outer contour 64 and the intermediate wall thickness exists, then the intermediate wall thickness is responsive to the outer contour 64 of the airfoil 14. The same principles apply to a final wall thickness of the airfoil.

Similarly, if the intermediate channel contour or the final channel contour (e.g. the cooling channel) follows a twist of the airfoil 14, for example, then the intermediate channel and/or the final channel are considered responsive to the outer contour 64 from the tip 20 to the base. Likewise, if at a given radial cross section a contour of the intermediate channel or of the final channel follows a respective portion of the outer contour 64, for example, then the intermediate channel and/or the final channel are considered responsive to the outer contour 64 at the radial location. So long as a relationship can be found between the outer contour 64 and the intermediate channel contour or the final channel contour, then the intermediate channel and/or the final channel are considered responsive to the outer contour 64.

Alternately, or in addition to varying the electrode feed rate to maintain a specified wall thickness, the amount of current through the first electrode 42 may be increased as the tip of the first electrode 42 approaches the base of the airfoil 14. The amount of material removed increases as the current increases. Thus, a diameter of the intermediate channel will increase in order to ensure the intermediate wall thicknesses are controlled as desired. The wall thicknesses and the channel diameter may be controlled by controlling the current to achieve the same results described above when the electrode feed rate is controlled.

The electrode feed rate and the current may be controlled independently or simultaneously as desired and may increase and/or decrease toward the base as necessary to achieve the desired profiles.

Alternately, or in addition, more than one ECM electrode may be used to form a single channel, for example, the pilot channel 40, the intermediate channel 90, or the final channel. In an example embodiment where the pilot channel 40 is formed via electrochemical machining, instead of using one ECM electrode to form the entire length of the pilot channel 40 in one operation, two ECM electrodes could be used. An ECM electrode could be inserted into the component from a first location and a complementary ECM electrode could be inserted into the component from a second, different location. Both ECM electrodes could electrochemically machine a respective portion of the pilot channel 40, and both portions together would form the completed pilot channel 40. Alternately, one ECM electrode could be used to in two operations, each operation forming a respective portion of the pilot channel 40.

The respective electrochemical machining operations could occur sequentially or simultaneously. In an exemplary embodiment with sequential machining, the ECM electrode could be inserted at the tip 20 of the airfoil (or other component) and progress toward the platform 12/base to machine a portion of the pilot channel 40, while the complementary ECM electrode could then be inserted at the base and progress toward the tip 20 to form a remainder of the pilot channel 40. In another exemplary embodiment the ECM electrode could be inserted at one location to form a portion of the pilot channel 40. After the first electrochemical machining operation completes the respective portion of the pilot channel 40, the ECM electrode could be retracted, the component repositioned, and the same ECM electrode may be inserted at another location to finish machining the remainder of the pilot channel 40. The operation that occurs second in time would simply stop upon reaching the portion of the pilot channel 40 formed by the operation that occurred first in time.

If the operations occur simultaneously, the ECM electrode could be inserted at the tip 20 of the airfoil (or other component) and progress toward the platform 12/base to machine a portion of the pilot channel 40, while the complementary ECM electrode is simultaneously inserted at the base to form a remainder of the pilot channel 40. The two ECM electrodes progress toward each other until they meet. Alternately, the operations could be a combination of sequential and simultaneous. For example, at one point in the operation both electrodes could be machining simultaneously until they get close to each other, at which point one electrode stops electrochemically machining, leaving the remainder of the pilot channel 40 to be electromechanically machined by the electrode that remains operational. Any combination of sequential and simultaneous may be applied.

Alternately, or in addition, the first electrode 42 may be masked to achieve the desired shape. This may occur when, for example, the cross sectional shape of the electrode is not the same as the desired contour. For example, if the first electrode 42 instead had a circular cross section, masking material could be selectively disposed on a first electrode pressure side 70 and on a first electrode suction side 72 but not on a first electrode leading edge 74 or on a first electrode trailing edge 76. (I.e. the first electrode 42 may be partly isolated.) In such an exemplary embodiment the masking would prevent machining (material removal) adjacent the first electrode pressure side 70 and the first electrode suction side 72, but would permit material removal adjacent the first electrode leading edge 74 and the first electrode trailing edge 76. Thus, when masked, it is possible for a first electrode 42 with a circular cross section to form a channel with an oval profile, and the diameter of the oval channel may be controlled by controlling the electrode feed rate and/or the current through the electrode. Any or all of these techniques may be employed as desired to achieve the desired contour and dimensions of the channel and wall and/or of a rib.

Also visible in FIG. 2 as dashed lines are a leading-edge cooling channel contour 80 and a trailing edge cooling channel contour 82 that may be formed used the same methods disclosed for forming the middle cooling channel.

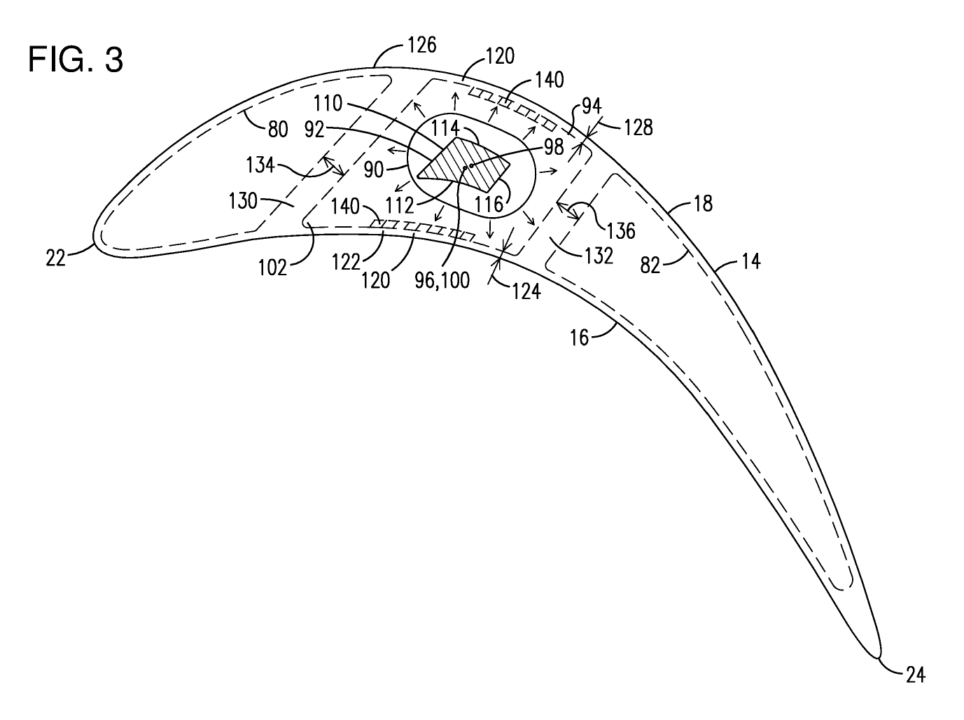

FIG. 3 shows a radial cross section of the airfoil 14 after the intermediate channel 90 has been formed and the first electrode 42 has been removed. A second electrode 92 is introduced into the intermediate channel 90 to enlarge it as shown by the arrows until the final channel having the final contour 94 is formed, where the final contour 94 represents a surface of the cooling channel once it is formed. The second electrode 92 may similarly be introduced from the tip 20 of the airfoil 14 and lowered into the airfoil 14 toward the base. The final channel may be formed using any or all of the techniques detailed above, including varying the feed rate of the second electrode 92 and/or varying the current through the second electrode 92. In addition the second electrode 92 (or any of the electrodes) may be shaped along its length and/or its cross section and/or masked to form the desired final contour 94.

In the exemplary embodiment of FIG. 3, the cross section of the second electrode 92 is shaped to match the final contour 94, and the second electrode 92 fits within the intermediate channel 90. Since the final contour 94 is not axisymmetric (i.e. it is asymmetric), the cross section of the second electrode 92 is not axisymmetric. As used herein, a cross section is not axisymmetric if it has no rotational symmetry. The cross section is axisymmetric because its shape at zero degrees rotation is not reproduced at any other angle of rotation; the cross section appears different to a stationary viewer at every rotational position.

In addition, in this exemplary embodiment a centroid 96 of the second electrode 92 may or may not coincide with a centroid 98 of the intermediate channel 90 at any or all points from the tip 20 to the base. This may occur when a centroid 100 of the final contour 94 also does not coincide with the intermediate channel centroid 98. This lack of coincidence may be a result of, for example, a skewed corner 102 of the final contour 94, or other similar feature of the final contour 94. Alternately, the pilot channel 40 and the intermediate channel 90 may be positioned so their respective centroids all coincide.

As a result of the eccentricity of the second electrode 92 within the intermediate channel 90, if the second electrode 92 is not masked, material may not be removed uniformly around the second electrode 92. For example, material adjacent a second electrode leading edge 110 and a second electrode pressure side 112 may be removed faster than material adjacent a second electrode suction side 114 and a second electrode trailing edge 116. Should this effect cause the final contour 94 to be reached sooner on the second electrode suction side 114 and the second electrode trailing edge 116, the second electrode centroid 96 can be repositioned within the cross section as necessary before and/or during the electrochemical machining operation. Similarly, the centroid for any electrode may be repositioned during the electrochemical machining operation to account for any expected or unexpected material removal rates to ensure that the desired contours are formed.

The second electrode 92 may be lowered into the airfoil 14 and blade 10 until the cooling channel is formed having the final contour 94. As a result an airfoil external wall 120 is formed, which may be considered to include a pressure side wall 122 having a pressure side wall thickness 124 and a suction side wall 126 having a suction side wall thickness 128. In an embodiment, once formed, the leading edge cooling channel (represented by the leading-edge cooling channel contour 80), the middle cooling channel (represented by the final contour 94), and the trailing edge cooling channel (represented by the trailing edge cooling channel contour 82) form respective portions of the pressure side wall 122 and the suction side wall 126, both of which are thin walls, thereby forming a component having a thin-walled airfoil. Between the leading edge cooling channel and the middle cooling channel a first rib 130 is formed, and between the middle cooling channel and the trailing edge cooling channel a second rib 132 is formed. A thickness 134 of the first rib 130 and a thickness 136 of the second rib 132 may also be controlled via electrochemical machining using the methods disclosed above.

Also visible in FIG. 3 are flow-interrupting elements 140. These may be any feature that will interrupt a flow of cooling fluid flowing through the cooling channel, such as trip-strips, dimples, turbulators etc. These may be machined into the surface of the pressure side wall 122 and/or the suction side wall 126 via the electrochemical machining process as well. This may be accomplished by using, for example a masked electrode as shown in FIG. 4, which is a side view of a feature-forming electrode 142 used to form the flow interrupting elements 140. The feature-forming electrode 142 may be introduced, for example, after the second electrode 92 has finished its role, to form these relatively small features in the wall(s). Masking 144 is selectively disposed on a pressure side 146 of the feature-forming electrode 142 and on a suction side (not shown) of the feature-forming electrode 142, leaving some exposed pressure side surface 148 of the feature-forming electrode 142 and some exposed suction side surface (not shown) of the feature-forming electrode 142. Masking 144 may also be disposed on a leading edge side 150 of the feature-forming electrode 142 and on a trailing edge side 152 of the feature-forming electrode 142.

The masking blocks the electrochemical machining such that electrochemical machining occurs only adjacent the exposed pressure side surface 148 and the exposed suction side surface (not shown). The flow-interrupting elements 140 are thus raised portions of the pressure side wall 122 and the suction side wall 126 between areas that were electrochemically machined by the exposed pressure side surface 148 of the feature-forming electrode 142 and the exposed suction side surface (not shown) of the feature-forming electrode 142. Alternately, or in addition, the masking 144 may be reversed and the flow-interrupting elements 140 may be electrochemically machined/recessed into the pressure side wall 122 and/or the suction side wall 126.

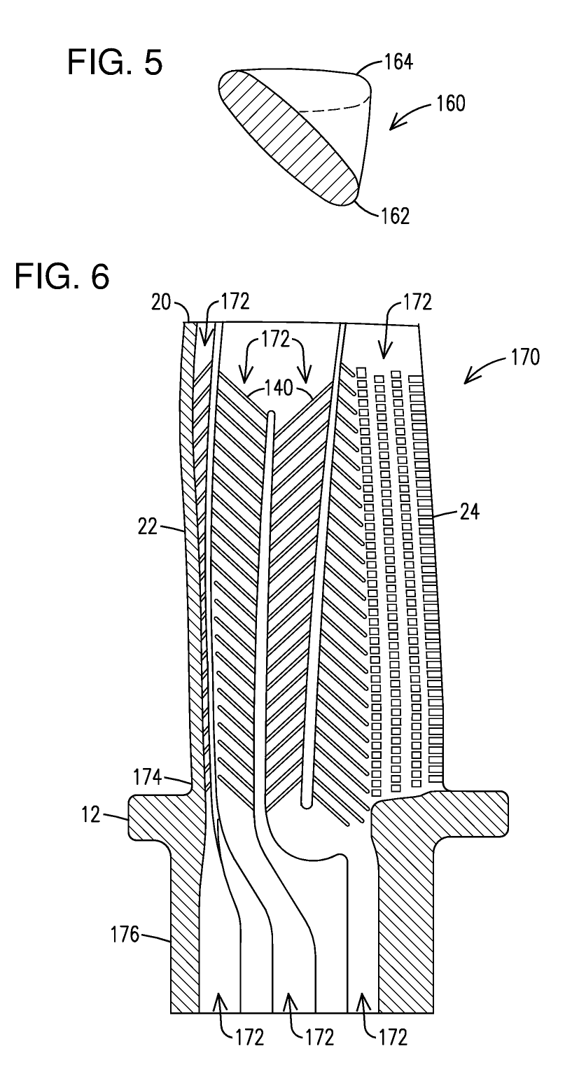

FIG. 5 is a top view of a twisted electrode 160 that exhibits a twist from a base end 162 of the twisted electrode 160 to a tip end 164. The twisted electrode 160 may be used with a twisted airfoil such as that shown in FIG. 1. As the twisted electrode 160 is lowered into the twisted airfoil the twisted electrode 160 may itself be rotated to form a cooling channel that follows the twist of the twisted blade.

FIG. 6 is a side cross section of an exemplary embodiment of a blade 170 after all electrochemical machining has been completed. Plural cooling channels 172 may be formed and any number may include flow-interrupting elements 140. The cooling channels 172 extend from the tip 20 of the airfoil to the base 174 of the airfoil, and may extend through the platform 12 and through the base 176 of the blade 170. Some or all of the cooling channels 172 may be completed (finish-machined) using electrochemical machining. Some or all of the pilot channels 40 may be created using electrochemical machining. When all of the pilot channels 40 and all of the cooling channels 172 are formed using electrochemical machining, then an entire interior contour, which is the sum of all of the individual final contours, is the result of electrochemical machining.

Once the machining (material removal) is complete, in certain exemplary embodiments the tip 20 of the airfoil 170 may be capped. This may occur in any way known to those in the art, including welding a tip cap (e.g. a metal plate, not shown) into place. Once the tip cap is secured, the blade is complete and may include a serpentine cooling channel. In an exemplary embodiment a relatively small hole may be formed at the tip for each cooling channel via electrochemical machining, the cooling channel may be formed with the diameter increased relative to the small hole using the methods disclosed above. Once the electrode is removed the small hole formed in the tip 20 may simply be welded closed. Alternately, the tip 20 may not be partly capped, or not capped at all.

The electrode may be lowered into the blade in other directions as necessary. For example, the electrode may be angled forward, backward, or to a side to form some of the more complex geometry. It is also possible that the electrode may be lowered into the blade 170 from the base 176 toward the tip 20 as necessary. Any and all of the above methods may be used as necessary to create the desired inner contours.

The inventors have proposed to use electrochemical machining in novel method of manufacturing a gas turbine engine component, such as a component including a thin-walled airfoil. This process dispenses with the need to have precise control of the formation of a core and/or the airfoil during an investment casting process, and in exemplary embodiments dispenses with the core entirely. This renders mood any associated tolerance control issues. In electrochemical machining the electrode does not contact the component or wear out when forming the component. Consequently, the electrode lasts longer than conventional machine tooling. Reduced heat and physical and thermal stresses occur during electrochemical machining, increasing part yield. As a result, components with tight tolerance control can be reliably and accurately formed with increased yield, and this may occur at a relatively lower cost. This is particularly true for high volume production operations, where the initial cost of the electrode is outweighed by the longer life. Consequently, the process represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of forming a component for a gas turbine engine, comprising:
casting the component around a ceramic core, wherein the ceramic core forms a pilot channel in the component, the pilot channel oriented from a base to a tip of the component;
sinking an electro-chemical machining (ECM) electrode into the pilot channel; and
enlarging the pilot channel to form an inner surface of an external wall of the component via electro-chemical machining, wherein a contour of the inner surface is different than a contour of the pilot channel.

2. The method of claim 1, wherein a contour of the ECM electrode matches a contour of the external wall.

3. The method of claim 1, wherein a contour of the ECM electrode matches a desired contour of the inner surface.

4. The method of claim 1, wherein the pilot channel is enlarged into a cooling channel, the method further comprising forming flow-interrupting elements in the cooling channel via the electro-chemical machining.

5. The method of claim 1, further comprising using at least two different ECM electrodes to enlarge the pilot channel, each ECM electrode comprising a different cross sectional shape.

6. The method of claim 1, further comprising using an ECM electrode comprising an asymmetric cross sectional shape that matches a desired contour to be formed in the component when enlarging the pilot channel.

7. The method of claim 1, further comprising using an ECM electrode that is partly-isolated to form a desired contour to be formed in the component when enlarging the pilot channel.

8. The method of claim 1, wherein the component is an airfoil, the method further comprising;
performing the electro-chemical machining from the tip of the airfoil toward the base; and
increasing a material removal rate as the ECM electrode approaches the base of the airfoil to control a thickness of the external wall.

9. The method of claim 1, further comprising sinking the ECM electrode from the tip of the component toward the base of the component to enlarge a portion of the pilot channel; and
sinking the ECM electrode or a complementary ECM electrode into the pilot channel from the base of the component toward the top of the component to enlarge a remainder of the pilot channel.

10. A method of forming a component for a gas turbine engine, comprising:
sinking an electro-chemical machining (ECM) electrode during electro-chemical machining into a pilot channel already formed in the component; and
enlarging the pilot channel to form a cooling channel within the component comprising a cross sectional shape that matches a cross sectional shape of an outer surface of an external wall of the component.

11. The method of claim 10, wherein the component comprises an airfoil, the method further comprising:
electro-chemical machining from a tip toward a base of the airfoil; and
slowing a sink rate of the ECM electrode or increasing current through the ECM electrode to remove more material as a thickness of the airfoil increases toward the base of the airfoil.

12. The method of claim 11, wherein the increased material removal is effective to maintain a constant thickness of the external wall or of a rib of the airfoil.

13. The method of claim 10, further comprising:
using the ECM electrode to expand the pilot channel initially; and
using a different ECM electrode to finish forming the cooling channel, wherein the different ECM electrode machines a different shape of the component.

14. The method of claim 10, wherein the component comprises an airfoil comprising a twisted shape, wherein a desired shape to be formed in the component follows the twist of the airfoil, and wherein the ECM electrode is shaped to match the twist of the desired shape to be formed.

15. The method of claim 10, wherein the ECM electrode comprises an asymmetric cross-sectional shape.

16. The method of claim 10, further comprising:
creating the component via an investment casting process around a core; and
removing the core to reveal the pilot channel.

17. The method of claim 10, further comprising forming flow-interrupting elements in the cooling channel via the electro-chemical machining.

18. The method of claim 10, further comprising forming the pilot channel via electrochemical machining.

19. The method of claim 10, further comprising using an ECM electrode that is partly-isolated.

20. The method of claim 10, further comprising sinking two ECM electrodes, each inserted at a different location on the component than the other, to electrochemically machine at least one of the pilot channel and the cooling channel.
